(19) United States
(12) Patent Application Publication
(10) Pub. No.: US 2025/0234137 A1
(43) Pub. Date: Jul. 17, 2025

(54) SYSTEM AND METHOD FOR LOW-PROFILE AUDIO DEVICE WITH FORCE CANCELLING TRANSDUCER

(71) Applicant: Harman International Industries, Incorporated, Stamford, CT (US)

(72) Inventors: Brian Sterling, Farmington Hills, MI (US); David Patrick Schneider, Bloomfield Hills, MI (US)

(21) Appl. No.: 18/876,154

(22) PCT Filed: Jun. 2, 2023
(86) PCT No.: PCT/US2023/067864

§ 371 Date: Dec. 17, 2024

Related U.S. Application Data
(60) Provisional application No. 63/368,007, filed on Jul. 8, 2022.

(51) Int. Cl. H04R 9/06; H04R 1/02; H04R 1/28

(52) U.S. Cl. CPC H04R 9/063; H04R 1/025; H04R 1/2873; H04R 2209/026; H04R 2499/13

(57) ABSTRACT

Methods and systems are provided for vehicle audio systems. In one or more embodiments, an audio device includes a first motor, a second motor, and a first diaphragm and a second diaphragm arranged opposite to each other, with the first diaphragm and the second diaphragm each driven by both of the first motor and the second motor. In one or more embodiments, the first motor and second motor may include respective biasing members. The biasing members may be conductive and may be energized to adjust forces applied to the diaphragms.

### CROSS REFERENCE TO RELATED APPLICATIONS

The present application claims priority to U.S. Provisional Application No. 63/368,007, entitled “SYSTEM AND METHOD FOR LOW-PROFILE AUDIO DEVICE WITH FORCE-CANCELLING TRANSDUCER”, and filed on Jul. 8, 2022. The entire contents of the above-listed application are hereby incorporated by reference for all purposes.

### FIELD

The disclosure relates to audio devices, and in particular, to low-profile audio devices for vehicle audio systems.

### BACKGROUND

Some vehicles include audio devices, such as speakers, configured to provide audio content to the operator and/or passengers of the vehicle. The audio devices often include transducers arranged at a center of a diaphragm. However, such configurations may increase a thickness of the audio device, which may be undesirable in configurations in which the audio device is arranged within a relatively small space of the vehicle and/or the vehicle space is occupied by other components. Further, a difficulty of providing a diaphragm with a high aspect ratio may be increased due to limited stiffness along the major axis of the diaphragm. Multiple transducers may be included at the center to provide a more acceptable stiffness along the major axis of the diaphragm. However, the additional transducers may have an increased size and may increase a cost and/or weight of the audio device.

### SUMMARY

In one or more embodiments, an audio device includes a first motor, a second motor, and a first diaphragm and a second diaphragm arranged opposite to each other. The first diaphragm and the second diaphragm are each driven by both of the first motor and the second motor.

In one or more embodiments, a system includes an audio device shaped to seat within a vehicle component or enclosure. The audio device includes a first motor and a second motor each extending in a vertical direction of the vehicle component or enclosure while the audio device is seated within the vehicle component or enclosure. The audio device further includes a first diaphragm and a second diaphragm each driven by both of the first motor and the second motor.

In one or more embodiments, a method includes generating an audio output from a low-profile audio device by driving a first diaphragm via a first transducer and a second transducer aligned with each other. The method additionally includes driving a second diaphragm via a third transducer and a fourth transducer.

### BRIEF DESCRIPTION OF THE DRAWINGS

The disclosure may be better understood from reading the following description of non-limiting embodiments, with reference to the attached drawings, wherein below:

FIG. 1 shows an audio system including a low-profile audio device removed from an opening of a vehicle door in accordance with one or more embodiments of the present disclosure;

FIG. 2 shows the audio system of FIG. 1 with the low-profile audio device seated within the opening of the vehicle door;

FIG. 3 shows a front view of the low-profile audio device of FIGS. 1-2;

FIG. 4 shows a side view of the low-profile audio device of FIGS. 1-3;

FIG. 5 shows a top view of the low-profile audio device of FIGS. 1-4;

FIG. 6 shows an example partial view of a vehicle cabin in accordance with one or more embodiments of the present disclosure;

FIG. 7 shows a block diagram of an example in-vehicle computing system of a vehicle with a digital media player, in accordance with one or more embodiments of the present disclosure;

FIG. 8 shows a flow chart illustrating a method for configuring a low-profile audio device within a vehicle, in accordance with one or more embodiments of the present disclosure.

FIG. 9 shows a flow chart illustrating a method for controlling operation of a low-profile audio device, in accordance with one or more embodiments of the present disclosure.

### DETAILED DESCRIPTION

The following description relates to systems and methods for vehicle audio systems. According to one or more embodiments of the present disclosure, a low-profile audio device includes a first motor arranged at a first end and a second motor arranged at a second end, opposite to the first motor. The first motor and second motor may each be arranged along a major axis of diaphragms of the low-profile audio device. The first motor may include a first transducer and a second transducer, and the second motor may include a third transducer and a fourth transducer. The first transducer and third transducer may each drive a first diaphragm, and the second transducer and fourth transducer may each drive a second diaphragm opposing the first diaphragm. In this configuration, the diaphragms may have a relatively large length in the direction of the major axis of the diaphragms, but a size of the low-profile audio device in a vertical direction may be decreased. The low-profile audio device may be seated within a vehicle component or enclosure, such as a vehicle panel or vehicle door, with the first diaphragm spaced apart from the second diaphragm in the vertical direction of the vehicle component or enclosure.

By arranging the motors at the opposing ends of the low-profile audio device, a stiffness of the diaphragms may be increased without increasing the size of the low-profile audio device in the vertical direction relative to configurations that include one or more motors at a center of the diaphragms. Further, relative to configurations which include motors at the center of the diaphragms, rocking modes may be reduced for the configurations disclosed herein while providing a high aspect ratio for the diaphragms.

According to one or more embodiments, the motors may include biasing members configured to bias the transducers of each motor. The biasing members may be formed from a magnetic material and may contribute to a magnetic return path of each motor, where electrical current flowing through each biasing member may generate a counter magnetic field to linearize each motor.

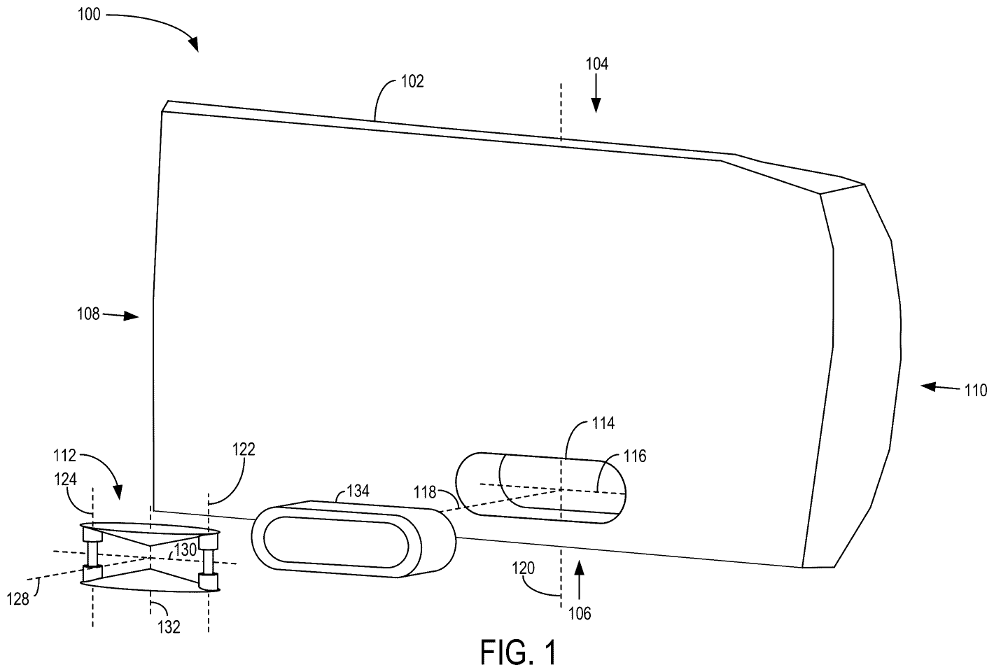

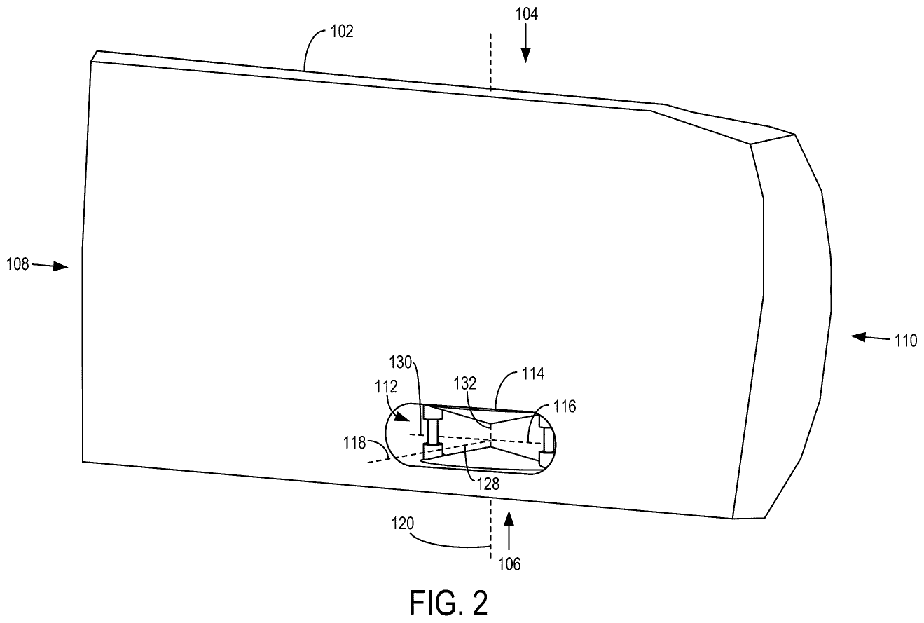

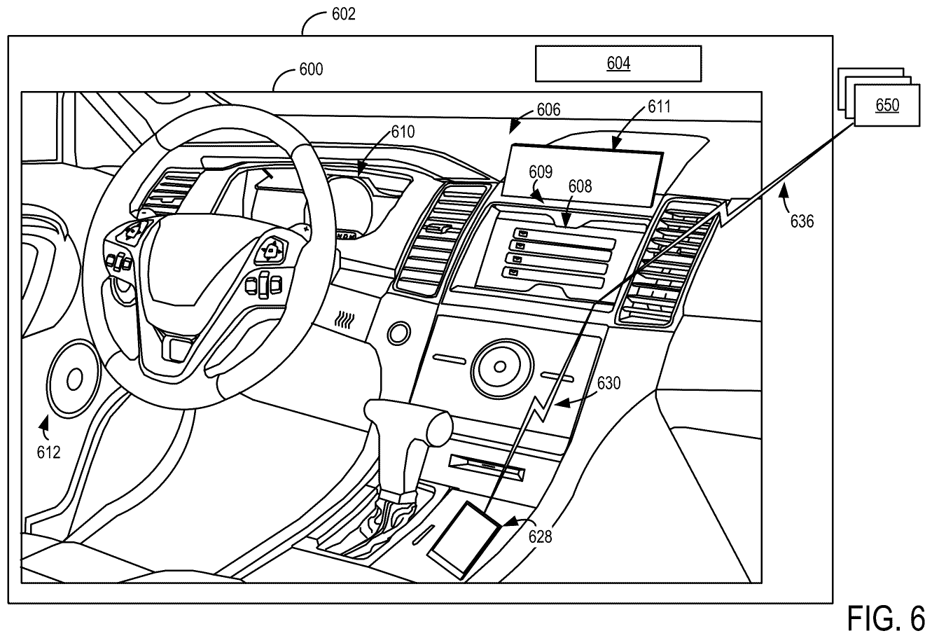

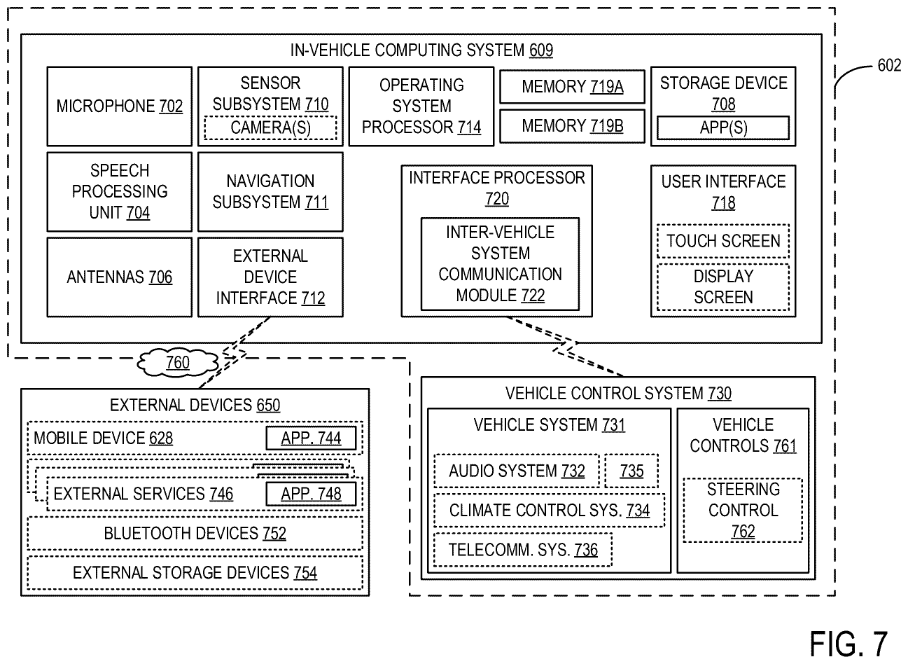

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as the audio system 100 described with reference to FIGS. 1-2, the low-profile audio device 112 described with reference to FIGS. 1-5, and/or the systems described with reference to FIGS. 6-7. The methods may be performed by executing stored instructions with one or more logic devices (e.g., processors) in combination with one or more additional hardware elements, such as storage devices, memory, hardware network interfaces/antennas, switches, actuators, clock circuits, etc. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

FIG. 1 shows a perspective view of an audio system 100 including a low-profile audio device 112. In the example shown, the low-profile audio device 112 is configured to seat within an opening 114 of a vehicle component 102, which may be an enclosure, vehicle panel (e.g., trim or sheet metal piece), vehicle seat, etc. included within an interior of the vehicle and/or forming a portion of a body of the vehicle. In the example shown, the vehicle component or enclosure is a vehicle door and is referred to herein as the vehicle door 102. The vehicle may be a car, truck, etc., and the vehicle door 102 may be a door (e.g., passenger door, driver door, etc.) of the car, truck, etc. In some examples, the low-profile audio device 112 may be configured to seat within an enclosure 134, and the enclosure 134 may be configured to seat within the opening 114 of the vehicle door 102. For example, the low-profile audio device 112 may be supported within the enclosure 134, and the enclosure 134 may be inserted into the opening 114 and supported by the vehicle door 102 within the opening 114.

The vehicle door includes a first end 108 and the second end 110 arranged opposite to each other. In some examples, the first end 108 may be arranged toward a front end of the vehicle including the vehicle door 102, where the front end of the vehicle is a portion of the vehicle including a windshield, steering wheel, driver seat, etc., and the rear end of the vehicle is the portion of the vehicle opposite to the front end (e.g., the portion of the vehicle including rear passenger seats, a trunk, a rear window, etc.).

In the view shown by FIG. 1, the low-profile audio device 112 is removed from the vehicle door 102. An axis 120 is shown extending vertically through a center of the opening 114, and an axis 116 is shown extending through the center of the opening in a horizontal direction perpendicular to the vertical direction. The horizontal direction extends from the first end to the second end 110 of the vehicle door 102. The vertical direction extends between a lower end 106 of the vehicle door 102 and an upper end 104 of the vehicle door 102. Further, an axis 118 is shown extending through the center of the opening 114 in a direction orthogonal to each of the horizontal direction and the vertical direction (e.g., perpendicular to each of the axis 116 and the axis 120). The axis hundred 16, the axis 118, and the axis 120 are each arranged relative to the opening 114.

FIG. 1 additionally shows an axis 132 extending vertically through a center of the low-profile audio device 112, axis 130 extending horizontally through the center of the low-profile audio device 112, and axis 128 extending through the center of the low-profile audio device 112 in a direction orthogonal to each of the horizontal direction and the vertical direction (e.g., perpendicular to the axis 132 and the axis 130). Axis 124 and axis 122 are additionally shown, with both of the axis 124 and the axis 122 extending in the vertical direction parallel with the axis 132. As described further below, the axis 124 and the axis 122 are arranged at opposing ends of the low-profile audio device 112. During conditions in which the low-profile audio device 112 is seated within the opening 114, as described further below, the axis 132 arranged along the vertical direction may be arranged coaxially with the axis 120 also arranged along the vertical direction.

Referring to FIG. 2, the low-profile audio device 112 is shown seated within the opening 114 without the enclosure 134 (although in some examples, the low-profile audio device 112 may be enclosed within the enclosure 134 within the opening 114 in the orientation shown by FIG. 2). In this configuration, the axis 120 and the axis 132 are arranged coaxially, the axis 130 and the axis 116 extending along the horizontal direction are arranged coaxially, and the axis 118 and the axis 128 are arranged coaxially, with the axis 118 and the axis 128 each orthogonal to the horizontal direction and the vertical direction.

The low-profile audio device 112 configured such that a size of the low-profile audio device 112 in the vertical direction is reduced relative to other configurations, which may reduce the amount of space occupied by the low-profile audio device 112 within the vehicle door 102 (e.g., within opening 114). Due to the reduced size of the low-profile audio device 112 in the vertical direction, the vehicle door 102 may be configured with a smaller opening 114, which may increase an amount of space within the vehicle door 102 for other vehicle components. Further, the reduced size of the low-profile audio device 112 may result in a reduced cost of the low-profile audio device 112, as described further below. The orientation of the low-profile audio device 112 within the opening 114 of the vehicle door 102 may increase a quality of audio (e.g., music, voice, etc.) generated by the low-profile audio device 112. For example, the configuration of the low-profile audio device 112 may increase a force-canceling of the low-profile audio device 112, which may result in increased audio quality.

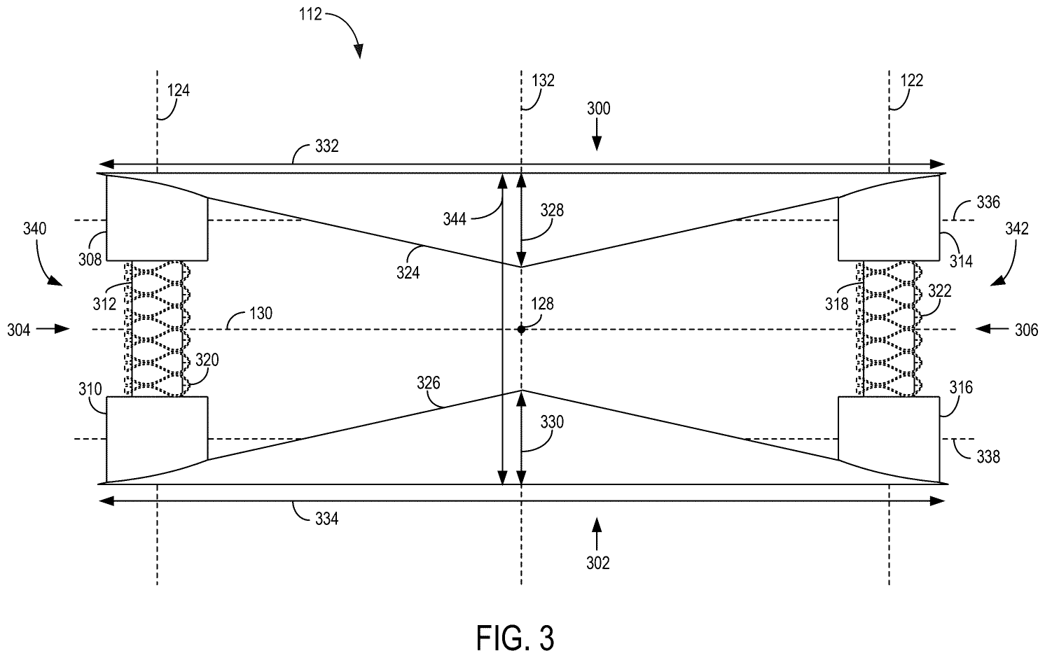

Referring to FIG. 3, a front view of the low-profile audio device 112 is shown. In the view shown by FIG. 3, the low-profile audio device 112 is removed from the vehicle door 102 shown by FIG. 1-2. However, for purposes of comparison, several of the axes shown by FIGS. 1-2 are also shown by FIG. 3. For example, axis 132 shown by FIG. 3, with the axis 132 arranged along the vertical direction during conditions in which the low-profile audio device 112 is coupled to the vehicle door 102 shown by FIGS. 1-2 (e.g., seated within the opening 114 of the vehicle door 102 as described above).

The low-profile audio device 112 includes a first diaphragm 324 arranged opposite to a second diaphragm 326 in the vertical direction. In particular, a center of the first diaphragm 324 and a center of the second diaphragm 326 may be aligned such that the axis 132 intersects each of the center of the first diaphragm 324 and the center of the second diaphragm 326. The first diaphragm 324 is arranged at an upper end 300 of the low-profile audio device 112, and the second diaphragm 326 is arranged at a lower end 302 of the low-profile audio device 112. During conditions in which the low-profile audio device 112 is coupled to the vehicle door 102 as shown by FIG. 2, a length between the upper end 300 of the low-profile audio device 112 and the lower end 106 of the vehicle door 102 (e.g., shown by FIGS. 1-2) is larger than a length between the lower end 302 of the low-profile audio device 112 and the lower end 106 of the vehicle door 102. Further, during conditions in which the low-profile audio device 112 is coupled to the vehicle door 102 as shown by FIG. 2, a first end 304 of the low-profile audio device 112 is arranged toward the first end 108 of the vehicle door 102 and a second end 306 of the low-profile audio device 112 is arranged toward the second end 110 of the vehicle door 102 (with the first end 108 and the second end 110 of the vehicle door 102 shown by FIG. 2).

The low-profile audio device 112 includes a first transducer 308 and a second transducer 310 arranged at the first end 304, and a third transducer 314 and a fourth transducer 316 arranged at the second end 306. The second transducer 310 and the fourth transducer 316 are arranged toward the lower end 302 of the low-profile audio device 112, and the first transducer 308 and the third transducer 314 are arranged toward the upper end 300 of the low-profile audio device 112. The first transducer 308 and the second transducer 310 are in a coaxial arrangement. In particular, the first transducer 308 and the second transducer 310 are each centered along axis 124, where the axis 124 extends in the vertical direction as described above. Further, the third transducer 314 and the fourth transducer 316 are in a coaxial arrangement, with each of the third transducer 314 and the fourth transducer 316 being centered along axis 122, where axis 122 extends in the vertical direction parallel with the axis 124.

The first transducer 308 may be horizontally aligned with the third transducer 314 along axis 336, and the second transducer 310 and the fourth transducer 316 may be horizontally aligned along the axis 338. The axis 336 and the axis 338 are each arranged parallel with the axis 130 and extend in the horizontal direction.

The first transducer 308 is coupled to a first support 312 toward the upper end 300 of the low-profile audio device 112, and the second transducer 310 is coupled to the first support 312 toward the lower end 302 of the low-profile audio device 112. Additionally, the third transducer 314 is coupled to a second support 318 toward the upper and 300 of the low-profile audio device 112, and the fourth transducer 316 is coupled to the second support 318 toward the lower end 302 of the low-profile audio device 112. The first transducer 308, the second transducer 310, and the first support 312 may be referred to collectively herein as a first motor 340. The third transducer 314, the fourth transducer 316, and the second support 318 may be referred to herein collectively as a second motor 342. In this configuration, the first motor 340 is arranged at the first end 304 of the low-profile audio device 112, and the second motor 342 is arranged at the opposing, second end 306 of the low-profile audio device 112.

During conditions in which the low-profile audio device 112 is operated (e.g., the low-profile audio device 112 receives signals from an electronic controller, such as a controller of the system's described further below with reference to FIG. 6 and FIG. 7), the first motor 340 and/or the second motor 342 may be energized in order to generate an audio output of the low-profile audio device 112. For example, the low-profile audio device 112 may convert analog and/or digital signals received by a controller to sound waves to provide audio (e.g., acoustic signals) for the driver and passenger of the vehicle (e.g., provide music, voice, etc.). The audio output may be generated by movement of the transducers responsive to signals provided to the transducers by the controller. For example, signals provided to the low-profile audio device 112 by a controller may command the low-profile audio device 112 to generate an audio output by energizing the first transducer 308 to move the first transducer 308 in the vertical direction (e.g., vibrate the first transducer 308 in the vertical direction). The movement of the first transducer 308 in the vertical direction may drive a movement of the first diaphragm 324 and the movement of the first diaphragm 324 in the vertical direction may result in generation of sound waves based on the signals received by the low-profile audio device 112.

The first transducer 308 and the third transducer 314 may each be coupled to the first diaphragm 324 in order to drive the first diaphragm 324 in the vertical direction responsive to signals received by the low-profile audio device 112 from the controller. Additionally, the second transducer 310 and fourth transducer 316 may each be coupled to the second diaphragm 326 in order to drive the second diaphragm 326 in the vertical direction responsive to signals received by the low-profile audio device 112 from the controller. In this configuration, the first transducer 308 and the third transducer 314 may each drive the first diaphragm 324 (e.g., drive the vibration of the first diaphragm 324 in the vertical direction), and the second transducer 310 and the fourth transducer 316 may strive the second diaphragm 326 (e.g., drive the vibration of the second diaphragm 326 in the vertical direction).

In the configuration shown by FIG. 3, the first diaphragm 324 has a length 332 in the horizontal direction along the major axis of the first diaphragm 324, and the second diaphragm 326 has a length 334 in the horizontal direction along the major axis of the second diaphragm 326. The major axis of the first diaphragm 324 and the major axis of the second diaphragm 326 are parallel to each other in the example shown (e.g., length 332 is in a same direction as length 334). The length 334 may be equal to the length 332. Further, the first diaphragm 324 has a depth 328 in the vertical direction (e.g., the direction parallel with axis 132) and the second diaphragm 326 has a depth 330 in the vertical direction. The depth 328 is in the same direction as the depth 330, and the depth 328 may be equal to the depth 330.

By configuring the first motor 340 and the second motor 342 to be at opposing ends of the low-profile audio device 112, the first diaphragm 324 and the second diaphragm 326 of the low-profile audio device 112 each has a high aspect ratio without increasing an overall depth 344 of the low-profile audio device 112 in the vertical direction relative to configurations that include motors arranged at the center of the diaphragms.

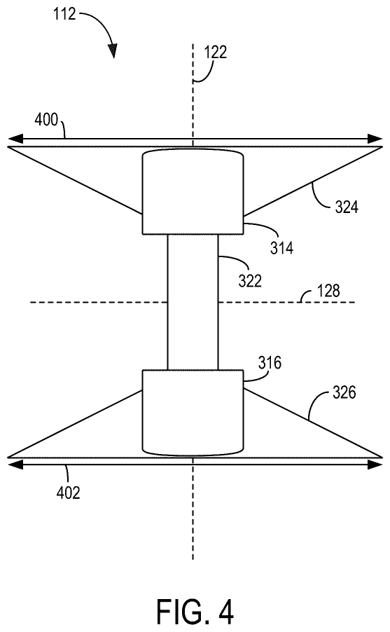

As shown by FIG. 4, the first diaphragm 324 has a width 400 in the direction perpendicular to the direction of length 332 shown by FIG. 3 and perpendicular to the direction of depth 328 shown by FIG. 3. The second diaphragm 326 has a width 402 in the direction perpendicular to the direction of length 334 shown by FIG. 3 and perpendicular to the direction of depth 330 shown by FIG. 3. The width 400 may be equal to the width 402, with the width 400 extending along the minor axis of first diaphragm 324 and with the width 402 extending along the minor axis of second diaphragm 326. Configuring the motors at the opposing ends of the low-profile audio device 112 as described above may increase the stiffness of the diaphragms, and as a result, the size of the width 400, width 402, length 332, and length 334 may be relatively large compared to the depth 328 and depth 330. The smaller depth 328 and depth 330 may reduce a vertical space occupied by the low-profile audio device 112 within the vehicle door. In some examples, the reduced vertical space occupied by the low-profile audio device 112 may enable the low-profile audio device 112 to be retrofitted to vehicle doors configured for other audio devices, which may reduce costs.

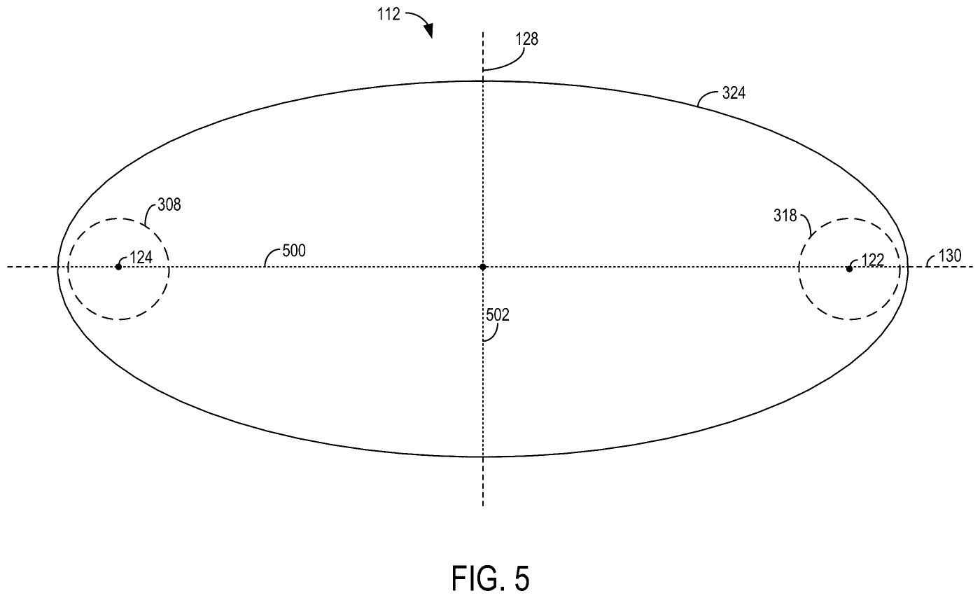

Referring to FIG. 5, a top view of the low-profile audio device 112 is shown. Each diaphragm may have an elliptical shape as shown, including the major axis and minor axis. For example, the major axis of first diaphragm 324 is indicated by axis 500 in FIG. 5, and the minor axis of first diaphragm 324 is indicated by axis 502 in FIG. 5. The axis 500 and the axis 502 are arranged parallel to each other. The axis 500 and/or the axis 502 may be referred to herein as the major axis of the low-profile audio device 112.

FIG. 6 shows an example partial view of one type of environment for an audio system including an audio device such as the low-profile audio device 112 described above: an interior of a cabin 600 of a vehicle 602, in which a driver and/or one or more passengers may be seated. Vehicle 602 of FIG. 6 may be a motor vehicle including drive wheels (not shown) and an internal combustion engine 604. Internal combustion engine 604 may include one or more combustion chambers which may receive intake air via an intake passage and exhaust combustion gases via an exhaust passage. Vehicle 602 may be a road automobile, among other types of vehicles. In some examples, vehicle 602 may include a hybrid propulsion system including an energy conversion device operable to absorb energy from vehicle motion and/or the engine and convert the absorbed energy to an energy form suitable for storage by an energy storage device. Vehicle 602 may include a fully electric vehicle, incorporating fuel cells, solar energy capturing elements, and/or other energy storage systems for powering the vehicle.

As shown, an instrument panel 606 may include various displays and controls accessible to a human driver (also referred to as the user) of vehicle 602. For example, instrument panel 606 may include a touch screen 608 of an in-vehicle computing system or infotainment system 609 (e.g., an infotainment system), an audio system control panel, and an instrument cluster 610. Touch screen 608 may receive user input to in-vehicle computing system or infotainment system 609 for controlling audio output, visual display output, user preferences, control parameter selection, and so on. While the example system shown in FIG. 6 includes audio system controls that may be performed via a user interface of in-vehicle computing system or infotainment system 609, such as touch screen 608 without a separate audio system control panel, in other embodiments, the vehicle may include an audio system control panel, which may include controls for a conventional vehicle audio system such as a radio, compact disc player, MP3 player, and so on. The audio system controls may include features for controlling one or more aspects of audio output via one or more speakers 612 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. The audio system controls may control audio output via the low-profile audio device 112 described above, as one example. In further examples, in-vehicle computing system or infotainment system 609 may adjust a radio station selection, a playlist selection, a source of audio input (e.g., from radio or CD or MP3), and so on, based on user input received directly via touch screen 608, or based on data regarding the user (such as a physical state and/or environment of the user) received via one or more external devices 650 and/or a mobile device 628. The audio system of the vehicle may include an amplifier (not shown) coupled to plurality of loudspeakers (not shown). In some embodiments, one or more hardware elements of in-vehicle computing system or infotainment system 609, such as touch screen 608, a display screen 611, various control dials, knobs and buttons, memory, processor(s), and any interface elements (e.g., connectors or ports) may form an integrated head unit that is installed in instrument panel 606 of the vehicle. The head unit may be fixedly or removably attached in instrument panel 606. In additional or alternative embodiments, one or more hardware elements of in-vehicle computing system or infotainment system 609 may be modular and may be installed in multiple locations of the vehicle.

Cabin 600 may include one or more sensors for monitoring the vehicle, the user, and/or the environment. For example, cabin 600 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in cabin 600, and so on. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, and so on. Information regarding ambient conditions of the vehicle, vehicle status, or vehicle driver may also be received from sensors external to/separate from the vehicle (that is, not part of the vehicle system), such as sensors coupled to external devices 650 and/or mobile device 628.

Cabin 600 may also include one or more user objects, such as mobile device 628, that are stored in the vehicle before, during, and/or after travelling. Mobile device 628 may include a smart phone, a tablet, a laptop computer, a portable media player, and/or any suitable mobile computing device. Mobile device 628 may be connected to in-vehicle computing system via a communication link 630. Communication link 630 may be wired (e.g., via Universal Serial Bus (USB), Mobile High-Definition Link (MHL), High-Definition Multimedia Interface (HDMI), Ethernet, and so on) or wireless (e.g., via Bluetooth®, Wi-Fi®, Wi-Fi Direct®, Near-Field Communication (NFC), cellular connectivity, and so on) and configured to provide two-way communication between the mobile device and the in-vehicle computing system. (Bluetooth® is a registered trademark of Bluetooth SIG, Inc., Kirkland, WA. Wi-Fi® and Wi-Fi Direct® are registered trademarks of Wi-Fi Alliance, Austin, Texas.) Mobile device 628 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, communication link 630 may provide sensor and/or control signals from various vehicle systems (such as vehicle audio system, climate control system, and so on) and touch screen 608 to mobile device 628 and may provide control and/or display signals from mobile device 628 to the in-vehicle systems and touch screen 608. Communication link 630 may also provide power to mobile device 628 from an in-vehicle power source in order to charge an internal battery of the mobile device.

In-vehicle computing system or infotainment system 609 may also be communicatively coupled to additional devices operated and/or accessed by the user but located external to vehicle 602, such as one or more external devices 650. In the depicted embodiment, external devices are located outside of vehicle 602 although it will be appreciated that in alternate embodiments, external devices may be located inside cabin 600. The external devices may include a server computing system, personal computing system, portable electronic device, electronic wrist band, electronic head band, portable music player, electronic activity tracking device, pedometer, smart-watch, GPS system, and so on. External devices 650 may be connected to the in-vehicle computing system via a communication link 636 which may be wired or wireless, as discussed with reference to communication link 630, and configured to provide two-way communication between the external devices and the in-vehicle computing system. For example, external devices 650 may include one or more sensors and communication link 636 may transmit sensor output from external devices 650 to in-vehicle computing system or infotainment system 609 and touch screen 608. External devices 650 may also store and/or receive information regarding contextual data, user behavior/preferences, operating rules, and so on and may transmit such information from external devices 650 to in-vehicle computing system or infotainment system 609 and touch screen 608.

In-vehicle computing system or infotainment system 609 may analyze the input received from external devices 650, mobile device 628, and/or other input sources and select settings for various in-vehicle systems (such as climate control system or audio system), provide output via touch screen 608 and/or speakers 612, a low-profile audio device such as low-profile audio device 112 described above, communicate with mobile device 628 and/or external devices 650, and/or perform other actions based on the assessment. In some embodiments, all or a portion of the assessment may be performed by mobile device 628 and/or external devices 650.

In some embodiments, one or more of external devices 650 may be communicatively coupled to in-vehicle computing system or infotainment system 609 indirectly, via mobile device 628 and/or another of external devices 650. For example, communication link 636 may communicatively couple external devices 650 to mobile device 628 such that output from external devices 650 is relayed to mobile device 628. Data received from external devices 650 may then be aggregated at mobile device 628 with data collected by mobile device 628, the aggregated data then transmitted to in-vehicle computing system or infotainment system 609 and touch screen 608 via communication link 630. Similar data aggregation may occur at a server system and then transmitted to in-vehicle computing system or infotainment system 609 and touch screen 608 via communication link 636 and/or communication link 630.

FIG. 7 shows a block diagram of an in-vehicle computing system or infotainment system 609 configured and/or integrated inside vehicle 602. In-vehicle computing system or infotainment system 609 may be referred to herein as a controller and/or electronic controller in some examples. In-vehicle computing system or infotainment system 609 may perform one or more of the methods described herein in some embodiments. In some examples, in-vehicle computing system or infotainment system 609 may be a vehicle infotainment system configured to provide information-based media content (audio and/or visual media content, including entertainment content, navigational services, and so on) to a vehicle user to enhance the operator's in-vehicle experience. In-vehicle computing system or infotainment system 609 may include, or be coupled to, various vehicle systems, sub-systems, hardware components, as well as software applications and systems that are integrated in, or integratable into, vehicle 602 in order to enhance an in-vehicle experience for a driver and/or a passenger. As one example, infotainment system 609 may include, or be coupled to, a low-profile audio device such as the low-profile audio device 112 described above.

In-vehicle computing system or infotainment system 609 may include one or more processors including an operating system processor 714 and an interface processor 720. Operating system processor 714 may execute an operating system on in-vehicle computing system or infotainment system 609, and control input/output, display, playback, and other operations of In-vehicle computing system or infotainment system 609. Interface processor 720 may interface with a vehicle control system 730 via an inter-vehicle system communication module 722.

Inter-vehicle system communication module 722 may output data to one or more other vehicle systems 731 and/or one or more other vehicle control elements 761, while also receiving data input from other vehicle systems 731 and other vehicle control elements 761, e.g., by way of vehicle control system 730. When outputting data, inter-vehicle system communication module 722 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System (GPS) sensors, and so on), digital signals propagated through vehicle data networks (such as an engine controller area network (CAN) bus through which engine related information may be communicated, a climate control CAN bus through which climate control related information may be communicated, and a multimedia data network through which multimedia data is communicated between multimedia components in the vehicle). For example, in-vehicle computing system or infotainment system 609 may retrieve from the engine CAN bus the current speed of the vehicle estimated by the wheel sensors, a power state of the vehicle via a battery and/or power distribution system of the vehicle, an ignition state of the vehicle, and so on. In addition, other interfacing means such as Ethernet may be used as well without departing from the scope of this disclosure.

A storage device 708 may be included in in-vehicle computing system or infotainment system 609 to store data such as instructions executable by operating system processor 714 and/or interface processor 720 in non-volatile form. Storage device 708 may store application data, including prerecorded sounds, to enable in-vehicle computing system or infotainment system 609 to run an application for connecting to a cloud-based server and/or collecting information for transmission to the cloud-based server. The application may retrieve information gathered by vehicle systems/sensors, input devices (e.g., a user interface 718), data stored in one or more storage devices, such as a volatile memory 719A or a non-volatile memory 719B, devices in communication with the in-vehicle computing system (e.g., a mobile device connected via a Bluetooth® link), and so on. (Bluetooth® is a registered trademark of Bluetooth SIG, Inc., Kirkland, WA.) In-vehicle computing system or infotainment system 609 may further include a volatile memory 719A. Volatile memory 719A may be random access memory (RAM). Non-transitory storage devices, such as non-volatile storage device 708 and/or non-volatile memory 719B, may store instructions and/or code that, when executed by a processor (e.g., operating system processor 714 and/or interface processor 720), controls in-vehicle computing system or infotainment system 609 to perform one or more of the actions described in the disclosure.

A microphone 702 may be included in in-vehicle computing system or infotainment system 609 to receive voice commands from a user, to measure ambient noise in the vehicle, to determine whether audio from speakers of the vehicle and/or a low-profile audio device (such as the low-profile audio device 112 described above) is tuned in accordance with an acoustic environment of the vehicle, and so on. A speech processing unit 704 may process voice commands, such as the voice commands received from microphone 702. In some embodiments, in-vehicle computing system or infotainment system 609 may also be able to receive voice commands and sample ambient vehicle noise using a microphone included in an audio system 732 of the vehicle.

One or more additional sensors may be included in a sensor subsystem 710 of in-vehicle computing system or infotainment system 609. For example, sensor subsystem 710 may include a camera, such as a rear view camera for assisting a user in parking the vehicle and/or a cabin camera for identifying a user (e.g., using facial recognition and/or user gestures). Sensor subsystem 710 of in-vehicle computing system or infotainment system 609 may communicate with and receive inputs from various vehicle sensors and may further receive user inputs. For example, the inputs received by sensor subsystem 710 may include transmission gear position, transmission clutch position, gas pedal input, brake input, transmission selector position, vehicle speed, engine speed, mass airflow through the engine, ambient temperature, intake air temperature, and so on, as well as inputs from climate control system sensors (such as heat transfer fluid temperature, antifreeze temperature, fan speed, passenger compartment temperature, desired passenger compartment temperature, ambient humidity, and so on), an audio sensor detecting voice commands issued by a user, a fob sensor receiving commands from and optionally tracking the geographic location/proximity of a fob of the vehicle, and so on.

While certain vehicle system sensors may communicate with sensor subsystem 710 alone, other sensors may communicate with both sensor subsystem 710 and vehicle control system 730, or may communicate with sensor subsystem 710 indirectly via vehicle control system 730. A navigation subsystem 711 of in-vehicle computing system or infotainment system 609 may generate and/or receive navigation information such as location information (e.g., via a GPS sensor and/or other sensors from sensor subsystem 710), route guidance, traffic information, point-of-interest (POI) identification, and/or provide other navigational services for the driver.

An external device interface 712 of in-vehicle computing system or infotainment system 609 may be coupleable to and/or communicate with one or more external devices 650 located external to vehicle 602. While the external devices are illustrated as being located external to vehicle 602, it is to be understood that they may be temporarily housed in vehicle 602, such as when the user is operating the external devices while operating vehicle 602. In other words, external devices 650 are not integral to vehicle 602. External devices 650 may include a mobile device 628 (e.g., connected via a Bluetooth®, NFC, WI-FI Direct®, or other wireless connection) or an alternate Bluetooth®-enabled device 752. (Wi-Fi Direct® is a registered trademark of Wi-Fi Alliance, Austin, Texas.)

Mobile device 628 may be a mobile phone, smart phone, wearable devices/sensors that may communicate with the in-vehicle computing system via wired and/or wireless communication, or other portable electronic device(s). Other external devices include one or more external services 746. For example, the external devices may include extra-vehicular devices that are separate from and located externally to the vehicle. Still other external devices include one or more external storage devices 754, such as solid-state drives, pen drives, Universal Serial Bus (USB) drives, and so on. External devices 650 may communicate with in-vehicle computing system or infotainment system 609 either wirelessly or via connectors without departing from the scope of this disclosure. For example, external devices 650 may communicate with in-vehicle computing system or infotainment system 609 through external device interface 712 over a network 760, a USB connection, a direct wired connection, a direct wireless connection, and/or other communication link.

External device interface 712 may provide a communication interface to enable the in-vehicle computing system to communicate with mobile devices associated with contacts of the driver. For example, external device interface 712 may enable phone calls to be established and/or text messages (e.g., Short Message Service (SMS), Multimedia Message Service (MMS), and so on) to be sent (e.g., via a cellular communications network) to a mobile device associated with a contact of the driver. External device interface 712 may additionally or alternatively provide a wireless communication interface to enable the in-vehicle computing system to synchronize data with one or more devices in the vehicle (e.g., the driver's mobile device) via Wi-Fi Direct®, as described in more detail below.

One or more applications 744 may be operable on mobile device 628. As an example, a mobile device application 744 may be operated to aggregate user data regarding interactions of the user with the mobile device. For example, mobile device application 744 may aggregate data regarding music playlists listened to by the user on the mobile device, telephone call logs (including a frequency and duration of telephone calls accepted by the user), positional information including locations frequented by the user and an amount of time spent at each location, and so on. The collected data may be transferred by application 744 to external device interface 712 over network 760. In addition, specific user data requests may be received at mobile device 628 from in-vehicle computing system or infotainment system 609 via external device interface 712. The specific data requests may include requests for determining where the user is geographically located, an ambient noise level and/or music genre at the user's location, an ambient weather condition (temperature, humidity, and so on) at the user's location, and so on. Mobile device application 744 may send control instructions to components (e.g., microphone, amplifier, and so on) or other applications (e.g., navigational applications) of mobile device 628 to enable the requested data to be collected on the mobile device or requested adjustment made to the components. Mobile device application 744 may then relay the collected information back to in-vehicle computing system or infotainment system 609.

Likewise, one or more applications 748 may be operable on external services 746. As an example, external services applications 748 may be operated to aggregate and/or analyze data from multiple data sources. For example, external services applications 748 may aggregate data from one or more social media accounts of the user, data from the in-vehicle computing system (e.g., sensor data, log files, user input, and so on), data from an internet query (e.g., weather data, POI data), and so on. The collected data may be transmitted to another device and/or analyzed by the application to determine a context of the driver, vehicle, and environment and perform an action based on the context (e.g., requesting/sending data to other devices).

Vehicle control system 730 may include controls for controlling aspects of various vehicle systems 731 involved in different in-vehicle functions. These may include, for example, controlling aspects of vehicle audio system 732 for providing audio entertainment to the vehicle occupants, aspects of a climate control system 734 for meeting the cabin cooling or heating needs of the vehicle occupants, as well as aspects of a telecommunication system 736 for enabling vehicle occupants to establish telecommunication linkage with others.

Audio system 732 may include one or more acoustic reproduction devices including electromagnetic transducers such as one or more speakers 735, low-profile audio devices such as the low-profile audio device 112 described above, etc. Vehicle audio system 732 may be passive or active such as by including a power amplifier. In some examples, in-vehicle computing system or infotainment system 609 may be a sole audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 734 may be configured to provide a comfortable environment within the cabin or passenger compartment of vehicle 602. Climate control system 734 includes components enabling controlled ventilation such as air vents, a heater, an air conditioner, an integrated heater and air-conditioner system, and so on. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 730 may also include controls for adjusting the settings of various vehicle control elements 761 (or vehicle controls, or vehicle system control elements) related to the engine and/or auxiliary elements within a cabin of the vehicle, such as one or more steering wheel controls 762 (e.g., steering wheel-mounted audio system controls, cruise controls, windshield wiper controls, headlight controls, turn signal controls, and so on), instrument panel controls, microphone(s), accelerator/brake/clutch pedals, a gear shift, door/window controls positioned in a driver or passenger door, seat controls, cabin light controls, audio system controls, cabin temperature controls, and so on. Vehicle control elements 761 may also include internal engine and vehicle operation controls (e.g., engine controller module, actuators, valves, and so on) that are configured to receive instructions via the CAN bus of the vehicle to change operation of one or more of the engine, exhaust system, transmission, and/or other vehicle system. The control signals may also control audio output at one or more speakers 735 of vehicle audio system 732. For example, the control signals may adjust audio output characteristics such as volume, equalization, audio image (e.g., the configuration of the audio signals to produce audio output that appears to a user to originate from one or more defined locations), audio distribution among a plurality of speakers, low-profile audio devices (such as low-profile audio device 112 described above), and so on. Likewise, the control signals may control vents, air conditioner, and/or heater of climate control system 734. For example, the control signals may increase delivery of cooled air to a specific section of the cabin.

Control elements positioned on an outside of a vehicle (e.g., controls for a security system) may also be connected to in-vehicle computing system or infotainment system 609, such as via inter-vehicle system communication module 722. The control elements of vehicle control system 730 may be physically and permanently positioned on and/or in the vehicle for receiving user input. In addition to receiving control instructions from in-vehicle computing system or infotainment system 609, vehicle control system 730 may also receive input from one or more external devices 650 operated by the user, such as from mobile device 628. This allows aspects of vehicle systems 731 and vehicle control elements 761 to be controlled based on user input received from external devices 650.

In-vehicle computing system or infotainment system 609 may further include one or more antennas 706. The in-vehicle computing system may obtain broadband wireless internet access via antennas 706, and may further receive broadcast signals such as radio, television, weather, traffic, and the like. In-vehicle computing system or infotainment system 609 may receive positioning signals such as GPS signals via antennas 706. The in-vehicle computing system may also receive wireless commands via radio frequency (RF) such as via antennas 706 or via infrared or other means through appropriate receiving devices. In some embodiments, antenna 706 may be included as part of audio system 732 or telecommunication system 736. Additionally, antenna 706 may provide AM/FM radio signals to external devices 650 (such as to mobile device 628) via external device interface 712.

One or more elements of in-vehicle computing system or infotainment system 609 may be controlled by a user via user interface 718. User interface 718 may include a graphical user interface presented on a touch screen, such as touch screen 608 and/or display screen 611 of FIG. 6, and/or user-actuated buttons, switches, knobs, dials, sliders, and so on. For example, user-actuated elements may include steering wheel controls, door and/or window controls, instrument panel controls, audio system settings, climate control system settings, and the like. A user may also interact with one or more applications of in-vehicle computing system or infotainment system 609 and mobile device 628 via user interface 718. In addition to receiving a user's vehicle setting preferences on user interface 718, vehicle settings selected by in-vehicle control system 730 may be displayed to a user on user interface 718. Notifications and other messages (e.g., received messages), as well as navigational assistance, may be displayed to the user on a display of the user interface. User preferences/information and/or responses to presented messages may be performed via user input to the user interface.

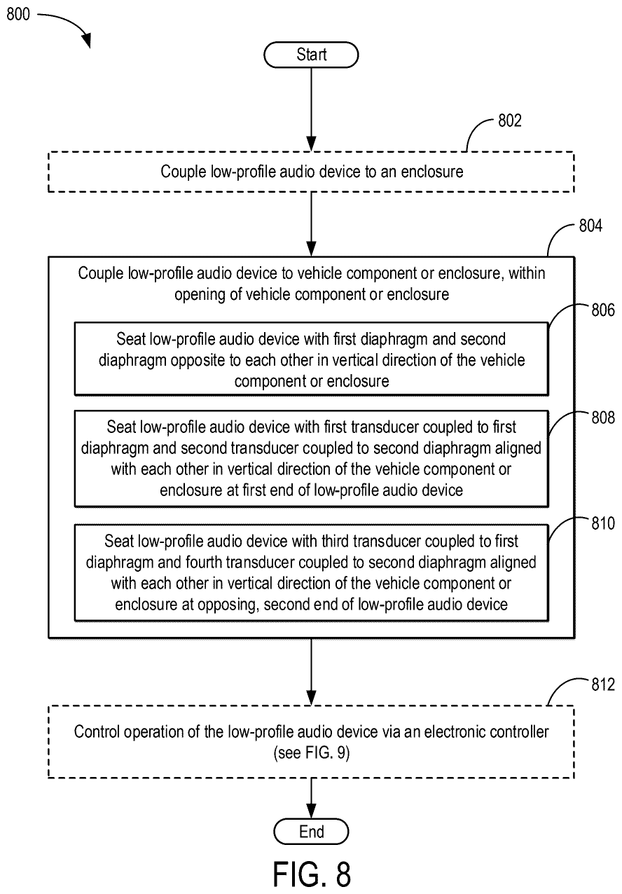

Referring to FIG. 8, a flow chart illustrating a method 800 for configuring a low-profile audio device within a vehicle is shown. The low-profile audio device may be similar to, or the same as, the low-profile audio device 112 shown by FIGS. 1-5 and described above.

At 802, the method may include coupling the low-profile audio device to an enclosure. The enclosure may be similar to, or the same as, the enclosure 134 shown by FIG. 1 and described above. For example, the enclosure may be configured to support components of the low-profile audio device within the vehicle, such as diaphragms, transducers, etc.

The method at 804 includes coupling the low-profile audio device to a vehicle component or enclosure, within an opening of the vehicle component or enclosure. The vehicle component or enclosure and opening may be similar to, or the same as, the vehicle door 102 and opening 114, respectively, described above with reference to FIGS. 1-2. In some examples, the vehicle component or enclosure may be a vehicle panel (e.g., trim or sheet metal piece), vehicle seat, etc. included within an interior of the vehicle and/or forming a portion of a body of the vehicle.

Coupling the low-profile audio device to the vehicle component or enclosure, within the opening of the vehicle component or enclosure, at 804 includes, at 806, seating the low-profile audio device with a first diaphragm and a second diaphragm opposite to each other in a vertical direction of the vehicle component or enclosure. As described above, the low-profile audio device may be similar to, or the same as, the low-profile audio device 112 shown by FIGS. 1-5 and described above. The first diaphragm and the second diaphragm may be similar to, or the same as, the first diaphragm 324 and the second diaphragm 326, respectively, described above with reference to FIGS. 3-5. The vertical direction of the vehicle component or enclosure may be the direction indicated by axis 120 (e.g., parallel to axis 120), shown by FIGS. 1-2 and described above. For example, the first diaphragm and the second diaphragm may be centered relative to each other along an axis such as the axis 132 shown by FIGS. 1-5 and described above, and seating the low-profile audio device with the first diaphragm and the second diaphragm opposite to each other in the vertical direction of the vehicle component or enclosure may include seating the low-profile audio device such that the axis along which the first diaphragm and the second diaphragm are centered is arranged coaxial with the vertical axis of the vehicle component or enclosure (e.g., the axis 120 shown by FIGS. 1-2). In this configuration, a center of the first diaphragm and a center of the second diaphragm are each arranged along the vertical axis of the vehicle component or enclosure, where the vertical axis extends in the vertical direction of the vehicle (e.g., a direction normal to a ground surface on which the vehicle sits, which may be a direction of gravity in some conditions, e.g., conditions in which the ground surface is flat and level).

Coupling the low-profile audio device to the vehicle component or enclosure, within the opening of the vehicle component or enclosure, at 804 includes, at 808, seating the low-profile audio device with a first transducer coupled to the first diaphragm and a second transducer coupled to the second diaphragm aligned with each other in the vertical direction of the vehicle component or enclosure at a first end of the low-profile audio device. For example, the first transducer and the second transducer may be similar to, or the same as, the first transducer 308 and the second transducer 310 shown by FIG. 3 and described above, where the first transducer 308 and the second transducer 310 are aligned (e.g., centered) along axis 124 extending in the vertical direction during conditions in which the low-profile audio device is seated within the opening of the vehicle component or enclosure, and the first transducer 308 and second transducer 310 are arranged at first end 304 of the low-profile audio device 112. The first transducer is coupled to the first diaphragm and is configured to drive the first diaphragm, and the second transducer is coupled to the second diaphragm and is configured to drive the second diaphragm.

Coupling the low-profile audio device to the vehicle component or enclosure, within the opening of the vehicle component or enclosure, at 804 includes, at 810, seating the low-profile audio device with a third transducer coupled to the first diaphragm and a fourth transducer coupled to the second diaphragm aligned with each other in the vertical direction of the vehicle component or enclosure at an opposing, second end of the low-profile audio device. For example, the third transducer and the fourth transducer may be similar to, or the same as, the third transducer 314 and the fourth transducer 316 shown by FIG. 3 and described above, where the third transducer 314 and the fourth transducer 316 are aligned (e.g., centered) along axis 122 extending in the vertical direction during conditions in which the low-profile audio device is seated within the opening of the vehicle component or enclosure, and the third transducer 314 and fourth transducer 316 are arranged at second end 306 of the low-profile audio device 112. The first transducer is coupled to the first diaphragm and is configured to drive the first diaphragm, and the second transducer is coupled to the second diaphragm and is configured to drive the second diaphragm.

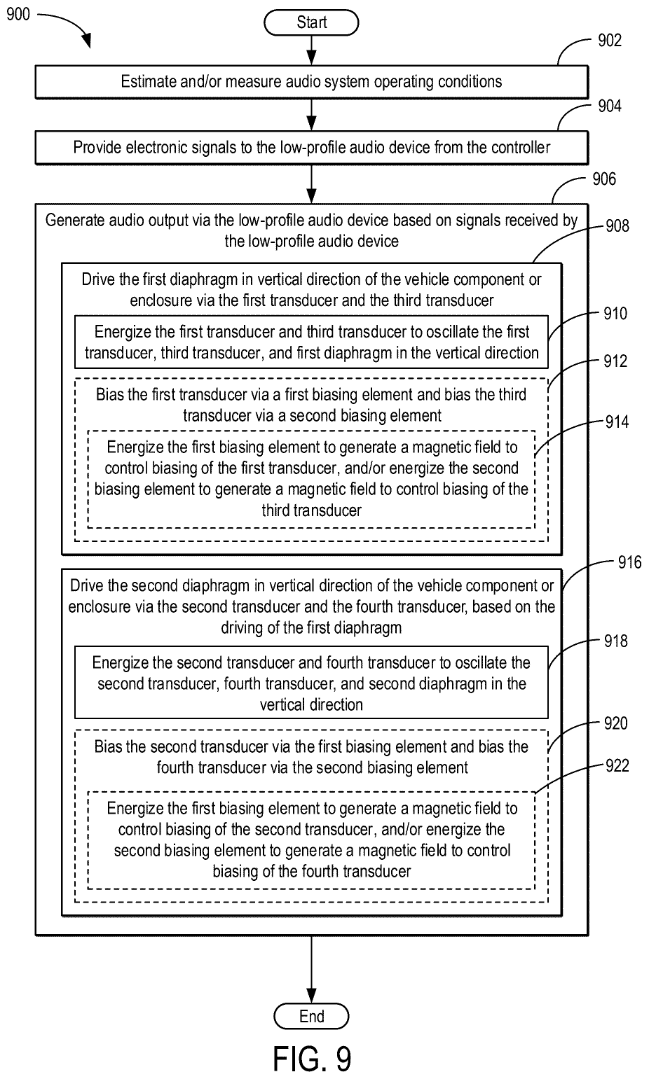

The method continues from 804 to 812 where the method may include controlling operation of the low-profile audio device via an electronic controller. The electronic controller may be similar to, or the same as, in-vehicle computing system or infotainment system 609 described above with reference to FIG. 6, in some examples. Controlling the operation of the low-profile audio device includes controlling signals provided to the low-profile audio device, as described below with FIG. 9.

Referring to FIG. 9, a flow chart illustrating a method 900 for controlling operation of a low-profile audio device via an electronic controller is shown. The low-profile audio device may be similar to, or the same as, the low-profile audio device 112 shown by FIGS. 1-5 and described above. In some examples, the low-profile audio device may be similar to, or the same as, the low-profile audio device described above with reference to FIG. 8. The low-profile audio device described with reference to method 900 includes components that are similar to, or the same as, the components of the low-profile audio device described above with reference to method 800 and in the same relative arrangement as described above, such as the transducers, diaphragms, etc. The similar (or same) components are not re-introduced in the description of method 900.

Instructions for carrying out method 900 and the rest of the methods included herein may be executed by a controller (e.g., in-vehicle computing system or infotainment system 609 described above with reference to FIG. 6) based on instructions stored on a memory of the controller and in conjunction with signals received from sensors of the vehicle, such as the sensors described above. The controller may employ actuators of components of the vehicle to adjust operation of the components, according to the methods described below.

At 902, the method includes estimating and/or measuring audio system operating conditions. Estimating and/or measuring audio system operating conditions may include, for example, determining whether components and/or devices of the audio system (e.g., the low-profile audio device) are energized, whether signals are provided to devices of the audio system for audio output, etc., determining whether an audio selection has been input by a user (e.g., driver) of the vehicle, etc.

The method continues from 902 to 904 where the method includes providing electronic signals to the low-profile audio device from the controller. The electronic signals may include electronic audio signals to be converted to sound waves by the low-profile audio device. For example, the electronic audio signals may include electronic signals provided to energize transducers of the low-profile audio device to cause a vibration of the transducers, where the vibration of the transducers may drive vibration of diaphragms of the low-profile audio device to convert the electronic signals to acoustic waves, as described below.

The method continues from 904 to 906 where the method includes generating audio output via the low-profile audio device based on signals received by the low-profile audio device.

Generating audio output via the low-profile audio device based on signals received by the low-profile audio device at 906 includes, at 908, driving the first diaphragm in the vertical direction of the vehicle component or enclosure via the first transducer and the third transducer. The vertical direction may be referred to herein as the driven direction of the first diaphragm.

Driving the first diaphragm in the vertical direction of the vehicle component or enclosure via the first transducer and the third transducer at 908 includes, at 910, energizing the first transducer and the third transducer to oscillate the first transducer, the third transducer, and the first diaphragm in the vertical direction. As described above, the first transducer, third transducer, and first diaphragm may be similar to, or the same as, the first transducer 308, third transducer 314, and first diaphragm 324, respectively, shown by FIG. 3. Referring to the configuration shown by FIG. 3 as one illustrative example, the electronic signals received by the low-profile audio device may energize the first transducer and the third transducer, resulting in a vibration of the first transducer and the third transducer. The vibration of the first transducer and the third transducer results in vibration of the first diaphragm 324 in the vertical direction, and the vibration of the first diaphragm generates acoustic signals based on the electronic signals provided to the first transducer and the third transducer.

The transducers described herein may be referred to as voice coils including electrically conductive windings configured to generate a magnetic field during conditions in which the transducers are energized by the electronic signals. The strength and direction of the magnetic field may be based on the amplitude and polarity of the electronic signals, and adjusting the parameters of the electronic signals may adjust the properties of the acoustic signals (e.g., sound waves) generated by low-profile audio device (e.g., via the first diaphragm).

Driving the first diaphragm in the vertical direction of the vehicle component or enclosure via the first transducer and the third transducer at 908 may further include, at 912, biasing the first transducer via a first biasing element and biasing the third transducer via a second biasing element. The first biasing element and the second biasing element may be similar to, or the same as, the first biasing element 320 and the second biasing element 322, respectively, shown by FIG. 3 and described above. The biasing elements may be springs, in some examples. As one example, the biasing elements may be wave spring. The biasing elements may provide a restoring force against the respective transducers to which the biasing elements are coupled. In particular, the first biasing element may provide a restoring force against the first transducer and the second biasing element may provide a restoring force against the second transducer.

During conditions in which the first transducer is moved responsive to electronic signals transmitted to the low-profile audio device to energize the first transducer, the first biasing element may apply the restoring force to the first transducer in a direction opposite to the direction of movement of the first transducer resulting from the energization of the first transducer via the electronic signals. As a result, the first transducer may vibrate during conditions in which the first transducer is energized, and as one example, the first transducer may vibrate during conditions in which the first transducer is energized with signals having a single polarity (e.g., conditions in which the first transducer moves in one direction vertically as a result of the energization of the first transducer), with the first biasing element configured to bias (e.g., urge) the first transducer in the vertical direction opposite to the direction of the movement of the first transducer that results from energization of the first transducer.

During conditions in which the third transducer is moved responsive to electronic signals transmitted to the low-profile audio device to energize the third transducer, the second biasing element may apply the restoring force to the third transducer in a direction opposite to the direction of movement of the third transducer resulting from the energization of the third transducer via the electronic signals. As a result, the third transducer may vibrate during conditions in which the third transducer is energized, and as one example, the third transducer may vibrate during conditions in which the third transducer is energized with signals having a single polarity (e.g., conditions in which the third transducer moves in one direction vertically as a result of the energization of the third transducer), with the second biasing element configured to bias (e.g., urge) the third transducer in the vertical direction opposite to the direction of the movement of the third transducer that results from energization of the third transducer.

Biasing the first transducer via the first biasing element and biasing the third transducer via the second biasing element at 912 may include, at 914, energizing the first biasing element to generate a magnetic field to control the biasing of the first transducer, and/or energizing the second biasing element to generate a magnetic field to control the biasing of the third transducer. As described above, the first biasing element may bias the first transducer and the second biasing element may bias the third transducer. In some examples, the first biasing element and/or the second biasing element may be formed from an electrically conductive material (e.g., a metal such as copper or copper alloy, steel, etc.). The first biasing element may be energized in order to adjust the restoring force applied to the first transducer by the first biasing element. For example, during conditions in which the first biasing element is energized, electrical current flowing through the first biasing element may generate a magnetic field based on the direction of the electrical current flow. The magnetic field may interact magnetically with the first transducer to apply force to the first transducer in an upward or downward vertical direction, either in the direction of the mechanical restoring force applied to the first transducer by the first biasing element (e.g., resulting from compression or expansion of the first biasing element) or in the direction opposite to the mechanical restoring force.

The controller may adjust the energization of the first biasing element based on operating conditions of the low-profile audio device (e.g., to increase or decrease the amount of magnetic interaction of the magnetic field generated by the first biasing element with the first transducer, change the direction of the magnetic field generated by the first biasing element, etc. in order to increase a performance of the low-profile audio device).

Although energization of the first biasing element is described above, the second biasing element may be energized in a similar way to adjust the strength, direction, etc. of force applied to the third transducer via a magnetic field generated by the second biasing element while the second biasing element is energized.

Generating audio output via the low-profile audio device based on signals received by the low-profile audio device at 906 further includes, at 916, driving the second diaphragm in the vertical direction of the vehicle component or enclosure via the second transducer and the fourth transducer, based on the driving of the first diaphragm. The vertical direction may be referred to herein as the driven direction of the second diaphragm.

Driving the second diaphragm based on the driving of the first diaphragm may include controlling the movement (e.g., driven vibration) of the second diaphragm such that the movement of the second diaphragm is equal in strength and opposite in direction to the movement of the first diaphragm. For example, during conditions in which the first diaphragm is driven based on electronic signals having a first waveform, the second diaphragm may be driven concurrently with the driving of the first diaphragm based on electronic signals having a second waveform with an equal amplitude and opposite polarity relative to the first waveform. In this configuration, as the first diaphragm is driven in a first vertical direction (e.g., upward direction) by a first amount, the second diaphragm is concurrently driven in a second vertical direction (e.g., downward direction) by the first amount. By driving the first diaphragm and the second diaphragm concurrently in opposite directions, a cancellation of inertial forces generated by operation of the low-profile audio device may be increased such that the driven vibration of the first diaphragm is balanced with the driven vibration of the second diaphragm. In other examples, however, the first diaphragm and second diaphragm may be driven concurrently in the same vertical direction depending on operating conditions of the audio system.

Driving the second diaphragm in the vertical direction of the vehicle component or enclosure via the second transducer and the fourth transducer at 916 includes, at 918, energizing the second transducer and the fourth transducer to oscillate the second transducer, fourth transducer, and the second diaphragm in the vertical direction. As described above, the second transducer, fourth transducer, and second diaphragm may be similar to, or the same as, the second transducer 310, fourth transducer 316, and second diaphragm 326, respectively, shown by FIG. 3. Referring to the configuration shown by FIG. 3 as one illustrative example, the electronic signals received by the low-profile audio device may energize the second transducer and the fourth transducer, resulting in a vibration of the second transducer and the fourth transducer. The vibration of the second transducer and the fourth transducer results in vibration of the second diaphragm 326 in the vertical direction, and the vibration of the second diaphragm generates acoustic signals based on the electronic signals provided to the second transducer and the fourth transducer.

Adjusting the parameters of the electronic signals provided to the second transducer and fourth transducer may adjust properties of the acoustic signals (e.g., sound waves) generated by low-profile audio device via the second diaphragm.

Driving the second diaphragm in the vertical direction of the vehicle component or enclosure via the second transducer and the fourth transducer at 916 may further include, at 920, biasing the second transducer via the first biasing element and biasing the fourth transducer via the second biasing element. The biasing elements may provide a restoring force against the respective transducers to which the biasing elements are coupled. As described above, the first biasing element may provide a restoring force against the second transducer and the second biasing element may provide a restoring force against the fourth transducer.

During conditions in which the second transducer is moved responsive to electronic signals transmitted to the low-profile audio device to energize the second transducer, the first biasing element may apply the restoring force to the second transducer in a direction opposite to the direction of movement of the second transducer resulting from the energization of the second transducer via the electronic signals. As a result, the second transducer may vibrate during conditions in which the second transducer is energized, and as one example, the second transducer may vibrate during conditions in which the second transducer is energized with signals having a single polarity (e.g., conditions in which the second transducer moves in one direction vertically as a result of the energization of the second transducer), with the first biasing element configured to bias (e.g., urge) the second transducer in the vertical direction opposite to the direction of the movement of the second transducer that results from energization of the second transducer.

During conditions in which the fourth transducer is moved responsive to electronic signals transmitted to the low-profile audio device to energize the fourth transducer, the second biasing element may apply the restoring force to the fourth transducer in a direction opposite to the direction of movement of the fourth transducer resulting from the energization of the fourth transducer via the electronic signals. As a result, the fourth transducer may vibrate during conditions in which the fourth transducer is energized, and as one example, the fourth transducer may vibrate during conditions in which the fourth transducer is energized with signals having a single polarity (e.g., conditions in which the fourth transducer moves in one direction vertically as a result of the energization of the fourth transducer), with the second biasing element configured to bias (e.g., urge) the fourth transducer in the vertical direction opposite to the direction of the movement of the fourth transducer that results from energization of the fourth transducer.

Biasing the second transducer via the first biasing element and biasing the fourth transducer via the second biasing element at 920 may include, at 922, energizing the first biasing element to generate a magnetic field to control the biasing of the second transducer, and/or energizing the second biasing element to generate a magnetic field to control the biasing of the fourth transducer. As described above, the first biasing element may bias the second transducer and the second biasing element may bias the fourth transducer. The first biasing element may be energized in order to adjust the restoring force applied to the second transducer by the first biasing element. For example, during conditions in which the first biasing element is energized, electrical current flowing through the first biasing element may generate a magnetic field based on the direction of the electrical current flow. The magnetic field may interact magnetically with the second transducer to apply force to the second transducer in an upward or downward vertical direction, either in the direction of the mechanical restoring force applied to the second transducer by the first biasing element (e.g., resulting from compression or expansion of the first biasing element) or in the direction opposite to the mechanical restoring force.

The controller may adjust the energization of the first biasing element based on operating conditions of the low-profile audio device (e.g., to increase or decrease the amount of magnetic interaction of the magnetic field generated by the first biasing element with the second transducer, change the direction of the magnetic field generated by the first biasing element, etc. in order to increase a performance of the low-profile audio device).

Although energization of the first biasing element is described above, the second biasing element may be energized in a similar way to adjust the strength, direction, etc. of force applied to the fourth transducer via a magnetic field generated by the second biasing element while the second biasing element is energized.

In the configurations described above, the low-profile audio device may be operated to generate sound (acoustic waves) for the operator and/or passenger of the vehicle while occupying a reduced space within the vehicle. Additionally, operation of the low-profile audio device may result in a reduced amount of undesired vibration of the low-profile audio device within the vehicle component or enclosure due to the force cancellation provided by the first diaphragm and second diaphragm being driven in opposite directions, which may increase a quality of audio signals generated by the low-profile audio device. By vertically aligning the first transducer and second transducer, inertial forces generated by the first transducer and second transducer may cancel each other. Similarly, by vertically aligning the third transducer and the fourth transducer, inertial forces generated by the third transducer and the fourth transducer may cancel each other. By arranging the first transducer and second transducer at the first end of the low-profile audio device and arranging the third transducer and fourth transducer at the second end of the low-profile audio device, the first diaphragm and second diaphragm are sufficiently supported by the transducers to increase a stiffness of the diaphragms without increasing the size of the central portion of the low-profile audio device. As a result, the low-profile audio device may be seated within relatively smaller spaces compared to other configurations, and the low-profile audio device may be retrofitted to existing spaces without modification in some examples, which may reduce costs.

FIGS. 1-5 are shown to scale, although other relative dimensions may be used, if desired.

The disclosure also provides support for an audio device, comprising: a first motor, a second motor, and a first diaphragm and a second diaphragm arranged opposite to each other and each driven by both of the first motor and the second motor. In a first example of the system, a first end of the first motor is arranged at the first diaphragm, a first end of the second motor is arranged at the first diaphragm, a second end of the first motor is arranged at the second diaphragm, and a second end of the second motor is arranged at the second diaphragm. In a second example of the system, optionally including the first example, the first motor and the second motor are arranged opposite to each other across a clearance formed between the first diaphragm and the second diaphragm. In a third example of the system, optionally including one or both of the first and second examples, the first motor and the second motor are arranged opposite to each other in a direction orthogonal to a driven direction of the first diaphragm and the second diaphragm. In a fourth example of the system, optionally including one or more or each of the first through third examples, the first motor includes a first transducer coupled to the first diaphragm and a second transducer coupled to the second diaphragm, and the second motor includes a third transducer coupled to the first diaphragm and a fourth transducer coupled to the second diaphragm. In a fifth example of the system, optionally including one or more or each of the first through fourth examples, the first transducer and the second transducer are arranged coaxially to each other, and the third transducer and the fourth transducer are arranged coaxially to each other. In a sixth example of the system, optionally including one or more or each of the first through fifth examples, a driven vibration of the first transducer balances a driven vibration of the second transducer, and a driven vibration of the third transducer balances a driven vibration of the fourth transducer. In a seventh example of the system, optionally including one or more or each of the first through sixth examples, the system further comprises: a first wave spring coupled between the first transducer and the second transducer, and a second wave spring coupled between the third transducer and the fourth transducer.

The disclosure also provides support for a system, comprising: an audio device shaped to seat within a vehicle component or enclosure, including: a first motor and a second motor each extending in a vertical direction of the vehicle component or enclosure while the audio device is seated within the vehicle component or enclosure, and a first diaphragm and a second diaphragm each driven by both of the first motor and the second motor. In a first example of the system, the first diaphragm and the second diaphragm are driven by both of the first motor and the second motor in the vertical direction, where the first motor is coupled to the first diaphragm and the second diaphragm at a first end of a major axis of the audio device and the second motor is coupled to the first diaphragm and the second diaphragm at a second end of the major axis. In a second example of the system, optionally including the first example, the system further comprises: a first electrically conductive biasing member engaged with each of a first transducer and a second transducer of the first motor. In a third example of the system, optionally including one or both of the first and second examples, the first electrically conductive biasing member is a wave spring.

The disclosure also provides support for a method, comprising: generating an audio output from a low-profile audio device including a first diaphragm, a second diaphragm aligned with the first diaphragm and arranged opposite to the first diaphragm in a direction perpendicular to a major axis and a minor axis of the first diaphragm, a first transducer aligned with a second transducer between the first diaphragm and the second diaphragm, and a third transducer aligned with a fourth transducer between the first diaphragm and the second diaphragm, by driving the first diaphragm via the first transducer and the third transducer and driving the second diaphragm via the second transducer and the fourth transducer. In a first example of the method, the method further comprises: coupling the low-profile audio device to a vehicle component or enclosure, within an opening of the vehicle component or enclosure, by seating the low-profile audio device with the first diaphragm and the second diaphragm opposite to each other in a vertical direction of the vehicle component or enclosure. In a second example of the method, optionally including the first example, coupling the low-profile audio device to the vehicle component or enclosure, within the opening of the vehicle component or enclosure, includes seating the low-profile audio device with the first transducer coupled to the first diaphragm and the second transducer coupled to the second diaphragm, where the first transducer and the second transducer are aligned with each other in the vertical direction of the vehicle component or enclosure at a first end of the low-profile audio device. In a third example of the method, optionally including one or both of the first and second examples, coupling the low-profile audio device to the vehicle component or enclosure, within the opening of the vehicle component or enclosure, includes seating the low-profile audio device with the third transducer coupled to the first diaphragm and the fourth transducer coupled to the second diaphragm, where the third transducer and the fourth transducer are aligned with each other in the vertical direction of the vehicle component or enclosure at an opposing, second end of the low-profile audio device. In a fourth example of the method, optionally including one or more or each of the first through third examples, driving the first diaphragm via the first transducer and the third transducer includes energizing the first transducer to drive the first diaphragm from a first end of the low-profile audio device and energizing the third transducer to drive the first diaphragm from an opposing, second end of the low-profile audio device. In a fifth example of the method, optionally including one or more or each of the first through fourth examples, driving the second diaphragm via the second transducer and the fourth transducer includes energizing the second transducer to drive the second diaphragm from a first end of the low-profile audio device and energizing the fourth transducer to drive the second diaphragm from a second end of the low-profile audio device. In a sixth example of the method, optionally including one or more or each of the first through fifth examples, driving the first diaphragm via the first transducer and the third transducer includes biasing the first transducer via a first biasing element and biasing the third transducer via a second biasing element, and driving the second diaphragm via the second transducer and the fourth transducer includes biasing the second transducer via the first biasing element and biasing the fourth transducer via the second biasing element. In a seventh example of the method, optionally including one or more or each of the first through sixth examples, biasing the first transducer via the first biasing element and biasing the second transducer via the first biasing element includes energizing the first biasing element to generate a magnetic field magnetically interacting with the first transducer and the second transducer, or biasing the third transducer via the second biasing element and biasing the fourth transducer via the second biasing element includes energizing the second biasing element to generate a magnetic field magnetically interacting with the third transducer and the fourth transducer.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. An audio device, comprising:
a first motor;
a second motor; and
a first diaphragm and a second diaphragm arranged opposite to each other and each driven by both of the first motor and the second motor, respectively.

2. The audio device of claim 1, wherein a first end of the first motor is arranged at the first diaphragm, a first end of the second motor is arranged at the first diaphragm, a second end of the first motor is arranged at the second diaphragm, and a second end of the second motor is arranged at the second diaphragm.

3. The audio device of claim 1, wherein the first motor and the second motor are arranged opposite to each other across a clearance formed between the first diaphragm and the second diaphragm.

4. The audio device of claim 1, wherein the first motor and the second motor are arranged opposite to each other in a direction orthogonal to a driven direction of the first diaphragm and the second diaphragm.

5. The audio device of claim 1, wherein the first motor includes a first transducer coupled to the first diaphragm and a second transducer coupled to the second diaphragm, and the second motor includes a third transducer coupled to the first diaphragm and a fourth transducer coupled to the second diaphragm.

6. The audio device of claim 5, wherein the first transducer and the second transducer are arranged coaxially to each other, and the third transducer and the fourth transducer are arranged coaxially to each other.

7. The audio device of claim 5, wherein a driven vibration of the first transducer balances a driven vibration of the second transducer, and a driven vibration of the third transducer balances a driven vibration of the fourth transducer.

8. The audio device of claim 5, further comprising a first wave spring coupled between the first transducer and the second transducer, and a second wave spring coupled between the third transducer and the fourth transducer.

9. A system, comprising:
an audio device shaped to seat within a vehicle component or enclosure, including:
a first motor and a second motor each extending in a vertical direction of the vehicle component or enclosure while the audio device is seated within the vehicle component or enclosure; and
a first diaphragm and a second diaphragm each driven by both of the first motor and the second motor.

10. The system of claim 9, wherein the first diaphragm and the second diaphragm are driven by both of the first motor and the second motor in the vertical direction, where the first motor is coupled to the first diaphragm and the second diaphragm at a first end of a major axis of the audio device and the second motor is coupled to the first diaphragm and the second diaphragm at a second end of the major axis.

11. The system of claim 9, further comprising a first electrically conductive biasing member engaged with each of a first transducer and a second transducer of the first motor.

12. The system of claim 11, wherein the first electrically conductive biasing member is a wave spring.

13. A method, comprising:
generating an audio output from a low-profile audio device including a first diaphragm, a second diaphragm aligned with the first diaphragm and arranged opposite to the first diaphragm in a direction perpendicular to a major axis and a minor axis of the first diaphragm, a first transducer aligned with a second transducer between the first diaphragm and the second diaphragm, and a third transducer aligned with a fourth transducer between the first diaphragm and the second diaphragm, by driving the first diaphragm via the first transducer and the third transducer and driving the second diaphragm via the second transducer and the fourth transducer.

14. The method of claim 13, further comprising: coupling the low-profile audio device to a vehicle component or enclosure, within an opening of the vehicle component or enclosure, by seating the low-profile audio device with the first diaphragm and the second diaphragm opposite to each other in a vertical direction of the vehicle component or enclosure.

15. The method of claim 14, wherein coupling the low-profile audio device to the vehicle component or enclosure, within the opening of the vehicle component or enclosure, includes seating the low-profile audio device with the first transducer coupled to the first diaphragm and the second transducer coupled to the second diaphragm, where the first transducer and the second transducer are aligned with each other in the vertical direction of the vehicle component or enclosure at a first end of the low-profile audio device.

16. The method of claim 15, wherein coupling the low-profile audio device to the vehicle component or enclosure, within the opening of the vehicle component or enclosure, includes seating the low-profile audio device with the third transducer coupled to the first diaphragm and the fourth transducer coupled to the second diaphragm, where the third transducer and the fourth transducer are aligned with each other in the vertical direction of the vehicle component or enclosure at an opposing, second end of the low-profile audio device.

17. The method of claim 13, wherein driving the first diaphragm via the first transducer and the third transducer includes energizing the first transducer to drive the first diaphragm from a first end of the low-profile audio device and energizing the third transducer to drive the first diaphragm from an opposing, second end of the low-profile audio device.

18. The method of claim 13, wherein driving the second diaphragm via the second transducer and the fourth transducer includes energizing the second transducer to drive the second diaphragm from a first end of the low-profile audio device and energizing the fourth transducer to drive the second diaphragm from a second end of the low-profile audio device.

19. The method of claim 13, wherein driving the first diaphragm via the first transducer and the third transducer includes biasing the first transducer via a first biasing element and biasing the third transducer via a second biasing element, and driving the second diaphragm via the second transducer and the fourth transducer includes biasing the second transducer via the first biasing element and biasing the fourth transducer via the second biasing element.

20. The method of claim 19, wherein biasing the first transducer via the first biasing element and biasing the second transducer via the first biasing element includes energizing the first biasing element to generate a magnetic field magnetically interacting with the first transducer and the second transducer, or biasing the third transducer via the second biasing element and biasing the fourth transducer via the second biasing element includes energizing the second biasing element to generate a magnetic field magnetically interacting with the third transducer and the fourth transducer.
